(19) United States
(12) Patent Application Publication
(10) Pub. No.: US 2026/0294158 A1
(43) Pub. Date: Oct. 1, 2026

(54) PORTABLE PRESS, GRINDER AND ACCESSORIES

(71) Applicant: AeroPress, Inc., Palo Alto, CA (US)

(72) Inventors: Matthew Brown, Raleigh, NC (US); Edmund Lee, Encino, CA (US)

(73) Assignee: AeroPress, Inc., Palo Alto, CA (US)

(21) Appl. No.: 19/630,012

(22) Filed: Mar. 26, 2026

Related U.S. Application Data
(60) Provisional application No. 63/778,288, filed on Mar. 26, 2025.

(51) Int. Cl. A47J 31/00; A47J 31/20; A47J 31/36

(52) U.S. Cl. CPC A47J 31/005; A47J 31/20; A47J 31/36

(57) ABSTRACT

A portable coffee press assembly, grinder and accessories. The portable coffee press assembly can be of a double-walled stainless steel design to improve insulative properties and facilitate manual handling during pressing. The portable grinder can be of a generally cylindrical design that fits into an open cavity of the piston of the press assembly. The grinder can include a removeable crank arm positionable in a storage configuration along the grinder body or in a grinding configuration extending laterally to facilitate manual grinding. The crank arm handle can be of generally circular shape to align along the top of the grinder and be magnetic to releasably secure to the grinder body. Portable accessories can further include a cup and lid with integrated filter storage, and a double-walled glass mug.

### CROSS-REFERENCE TO RELATED APPLICATIONS

The present application is a Non-Provisional of and claims the benefit of priority to U.S. Provisional Application No. 63/778,288 filed Mar. 26, 2025, the full disclosures of which are incorporated herein by reference in their entirety for all purposes.

### FIELD OF THE INVENTION

The present invention relates generally to beverage makers and more specifically to portables coffee products, including presses, grinders, cups, lids and accessories.

### BRIEF SUMMARY

In one aspect, the invention pertains to a portable beverage press assembly for making beverages, especially coffee presses for making coffee. In some embodiments, the portable press assembly includes: a beverage filter press that includes: a hollow cylinder having a first opening at a top side and a second opening at a bottom side, where the hollow cylinder is made from stainless steel. In some embodiments, the hollow cylinder and piston are stainless steel. In some embodiments, the hollow cylinder has a double-walled sidewall to improve insulation and facilitate manual handling of the hollow cylinder during pressing of a hot beverage. The press assembly can further include a removable filter cap couplable to the hollow cylinder so as to enclose the second opening, and a piston configured to be inserted into the hollow cylinder to press the beverage through a filter in the filter cap. In some embodiments, the piston is insertable through the top opening. In some embodiments, the piston is confined within the cylinder by a reduce diameter top opening. In some embodiments, the piston is a hollow tube having a distal plunger to create an airtight seal when inserted and pressed into the hollow cylinder. In some embodiments, the piston is formed of stainless steel and the distal plunger is formed of silicone. In some embodiments, the hollow cylinder has a substantially constant diameter (e.g. +/−10%) along its length such that the a distal plunger of the piston sealingly engages the inside of the cylinder along its length during pressing. A change in diameter of 10% is relatively minimal such that the operation of the press is effectively the same as a press having a constant diameter between top and bottom openings. In some embodiments, the cylinder and/or the piston includes a protective coating to facilitate use and ease of cleaning. In some embodiments, the press assembly can include various differing types of filter caps that supports a paper or metal filters, such as a standard cap with multiple holes to produce a standard coffee or one or more pressure-activated valves to create higher pressure and produce a more espresso like beverage.

In another aspect, the invention pertains to a portable grinder for manually grinding coffee beans. In some embodiments, the portable grinder can include: an elongate body of a generally cylindrical shape extending longitudinally between a top end and a bottom end, where the elongate body at least partly encloses an axle with cone burr, where a top end of the axle extends from the top end of the elongate body; a crank arm having an elongate member extending longitudinally between a proximal handle and a distal coupler. The handle is configured for manual grinding and the distal coupler is configured for operably engaging with the top end of the axle. The crank arm is removable from the elongate body to facilitate converting the grinder between differing configurations. In some embodiments, the grinder has a storage configuration in which the proximal handle removably couples with the top end of the elongate body with the elongate member extending longitudinally along a side of the elongate body so that the grinder has a reduced profile for storage. In some embodiments, the grinder has a grinding configuration in which the distal coupler is coupled to the top end of the axle such that manually operating the crank arm with the handle rotates the axle, thereby rotating the cone burr to facilitate grinding. The ground beans can be expelled below into the press or a removable grounds hopper.

In some embodiments, the portable grinder is configured to fit within the cylinder or open cavity of the piston of a coffee press assembly for storage and transport. In some embodiments, at least a distal portion of the grinder fits within the piston of the press assembly. In some embodiments, at least a portion of the elongate body has a flattened side extending longitudinally along which the elongate member of the crank arm extends when in the storage configuration. The proximal handle can be of a generally round shape so as to fit atop the top end of the generally cylindrically shaped elongate body. In some embodiments, the proximal handle is magnetic so as to releasably secure the proximal handle atop the elongate body in the storage configuration. In some embodiments, the crank handle is magnetically held alongside the elongate body in the storage configuration. In some embodiments, the proximal coupler is a hole formed along a proximal region of the elongate member that is shaped (e.g. square, polygonal, non-circular shape) to securely interface with the top end of the axle.

In yet another aspect, the invention pertains to a portable cup and lid for making and drinking coffee beverage as can be made from a coffee press assembly, such as any of those described herein. In some embodiments, the cup and lid is configured to contain and store a coffee press assembly for storage and transport of the coffee press assembly and associated components, including a stirrer, beverage cap, and filters. In some embodiments, the cup is configured to accommodate a portable coffee press. In some embodiments, the lid includes: a main body configured to removably and sealingly couple with the portable cup so as to securely contain the portable coffee press assembly therein and to securely contain a beverage disposed within the cup.

In some embodiments, the lid includes a storage chamber defined in a top of the main body, the chamber being sized and dimensioned to store a stack of paper filters for use with the portable press assembly and/or one or more metal filters. In some embodiments, the lid includes a top cover that encloses the storage cavity for storage of the filters, where the top cover is openable to access the storage cavity. In some embodiments, the top cover is fully removable. In some embodiments, the top cover remains partly attached such as by a hinge or tether. In some embodiments, the top cover has a snap-fit feature that circumscribes a bottom side of the cover so as to releasably couple atop the storage chamber. In some embodiments, the main body includes an open cavity that opens to a large bottom opening that fits atop the portable cup, where the open cavity is dimensioned to accommodate a portable press assembly when disposed within the portable cup for storage. In some embodiments, the main body includes threads or a snap-fit feature that interfaces with a top of the portable cup, thereby sealingly coupling the lid to the portable cup.

In still another aspect, the invention pertains to a glass mug or cup for drinking hot beverages, such as coffee beverages made from a portable coffee press assembly. In some embodiments, the mug or cup includes: a container body having a chamber configured to hold a hot liquid and a base configured to support the container upright. In some embodiments, the container is formed of glass and has double-walled sidewalls to insulate the beverage and facilitate manual handling. In some embodiments, the cup is a mug and includes a handle extending from the container body. The container body and handle can both be formed of glass. In some embodiments, the sidewalls of the cup or mug curve inwards toward a reduced size base so as to keep the beverage hotter for longer periods of time. In some embodiments, the reduced size base has a polygonal shape having four or more sides so as to improve stability of the mug. In some embodiments, the polygonal shape is a hexagon.

A further understanding of the nature and advantages of the present invention may be realized by reference to the remaining portions of the specification and the drawings.

### BRIEF DESCRIPTION OF THE DRAWINGS

FIGS. 1A-1B show upper and lower perspective views of an exemplary portable coffee filter press made from metal, such as stainless steel, in accordance with some embodiments;

FIG. 2 shows an exploded view of the press assembly, in accordance with some embodiments;

FIG. 3 shows a sectional view of the press assembly, in accordance with some embodiments;

FIGS. 4A-4B show detail view of the sidewalls of the piston and cylinder of the press assembly, in accordance with some embodiments;

FIGS. 5A-5B show of a hollow cylinder and piston, respectively, in accordance with some embodiments; and FIGS. 5C-D show cross-sectional views of the hollow cylinder and piston, respectively, in accordance with some embodiments;

FIG. 6 shows a cross-sectional view of an exemplary press assembly, in accordance with some embodiments;

FIG. 7A shows an exemplary press setup including a stainless steel press assembly on a coffee cup, scoop and stirrer, in accordance with some embodiments; FIG. 7B shows an alternative stainless steel press assembly with a protective coating and outside fill markings, in accordance with some embodiments;

FIG. 8 shows internal fill marking(s) defined inside the hollow cylinder, in accordance with some embodiments;

FIGS. 9A-9B show alternative designs of hollow cylinder with having a taper and enlarged diameter along a lower portion, in accordance with some embodiments;

FIG. 10 shows an alternative piston design having centering features disposed thereon, in accordance with some embodiments;

FIG. 11 shows an alternative piston design having an expandable distal seal, in accordance with some embodiments.

FIGS. 12A-12B illustrate an exemplary portable grinder with removable crank handle; FIG. 12C shows a cross-section of the portable grinder in the grinding configuration; and FIG. 12D shows the portable grinder fit into the open cavity of an exemplary coffee filter press for storage or transport, in accordance with some embodiments.

FIG. 13 illustrates an exemplary portable cup and lid for containing a portable coffee press assembly and drinking a hot beverage, the lid having a filter storage cavity, in accordance with some embodiments.

FIG. 14A illustrates an exemplary beverage press resting on a cup with a stirrer deployed for mixing the beverage before filter pressing, in accordance with some embodiments; FIG. 14B illustrates the exemplary beverage press with the piston deployed during the pressing stage, in accordance with some embodiments.

FIG. 15 illustrates an alternative version with the support extending radially outward from the cap, in accordance with some embodiments.

FIGS. 16A-16B illustrate a conventional portable press assembly with unitary flexible lid.

FIGS. 17A-17B illustrate an exemplary portable travel cup and lid for storing a portable or press assembly that includes a lid with filter storage, in accordance with some embodiments.

FIGS. 18A-18B illustrate the lid having a removable cap for placement and removal of filter papers, in accordance with some embodiments.

FIGS. 19A-19B illustrate an exemplary glass mug having double-walled for filter pressing and insulating hot beverages, in accordance with some embodiments.

FIG. 20 illustrate a sectional view of the glass mug that shows the double-walled aspect of the mug, in accordance with some embodiments.

### DETAILED DESCRIPTION

In one aspect, the invention pertains to portable beverage filter presses and associated accessory products, such as a portable grinder, a portable cup and lid having paper filter storage, and a glass mug. It is appreciated that the invention can pertain to any of these components individually or in combination within a beverage pressing assembly or set of products.

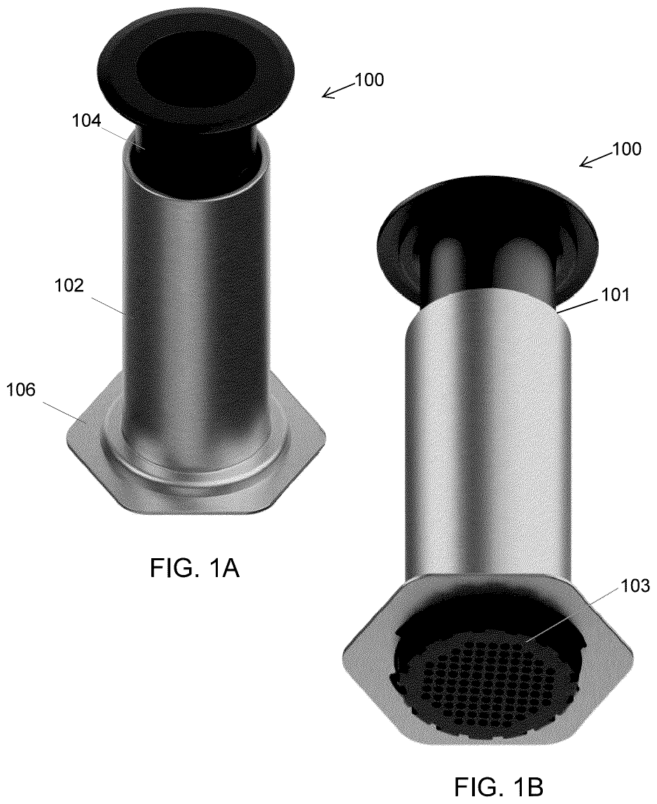

FIGS. 1A-1B illustrate an exemplary coffee maker 100 that includes a coffee press 101, which includes an outer cylinder 102 and piston 104 inserted into the cylinder, and a filter cap 103 that attaches to the bottom opening of the cylinder and supports a filter through which the coffee beverage is pressed by advancing the piston 104 through the cylinder 102. The outer cylinder includes a laterally extending support 106 that can be placed atop a container during pressing. In one aspect, the outer cylinder 102 is formed of stainless steel, which in some respects can be advantageous over polypropylene and glass cylinders, as stainless steel is more resistant to damage and staining. Additionally, for some consumers, the appearance of stainless is preferred as it matches other stainless steel products and appliances commonly found in high-end kitchens.

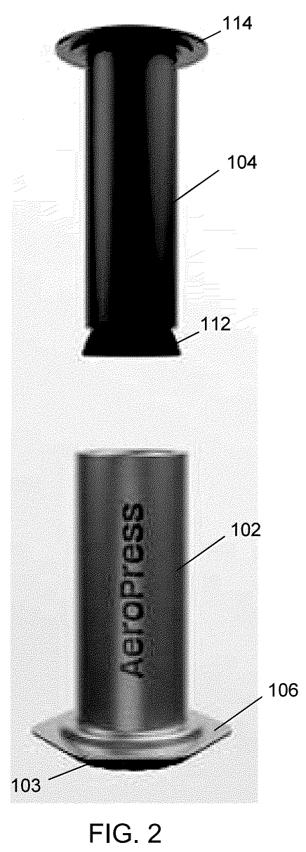

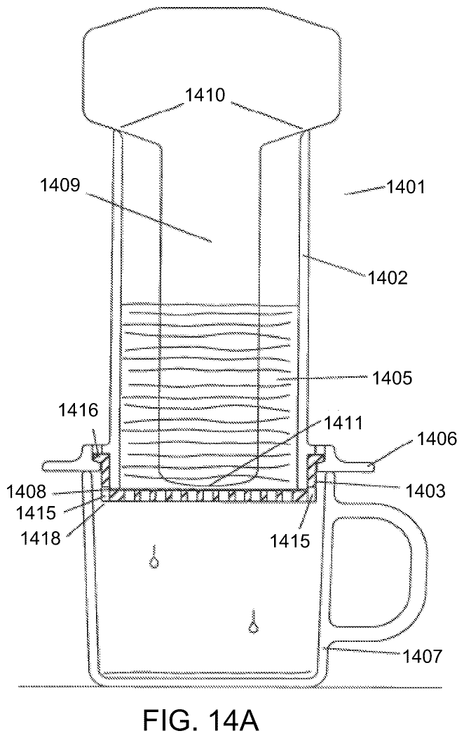

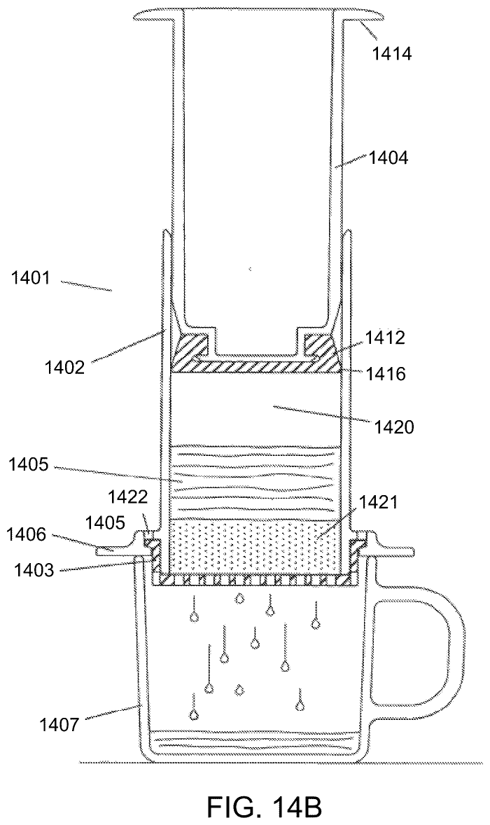

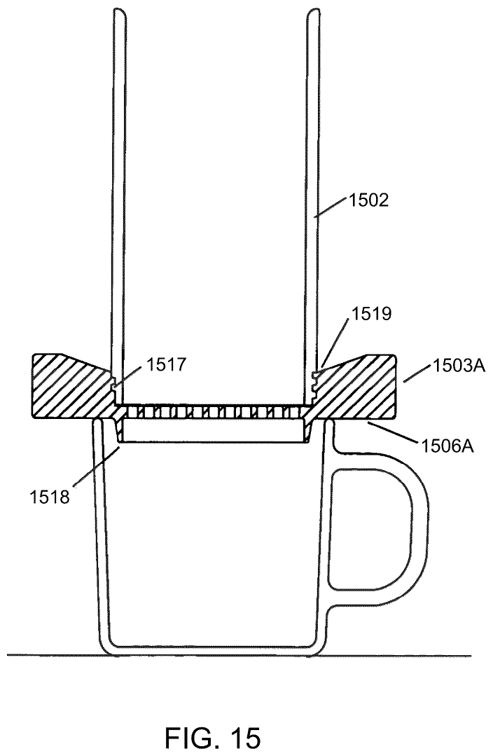

FIG. 2 shows another view of the press assembly is shown in FIG. 1B with the piston 104 removed from the outer cylinder 102. Either the cylinder 102 or the piston 104 may include a coating on the stainless steel. The coating can be a protective coating (e.g. Teflon, polymer, etc.) or color coating, textural coating, or the piston and cylinder can be without any coating in some embodiments. In other embodiments, the piston can be a different material (e.g. non-metal, polypropylene) than the cylinder. The piston 104 includes a plunger 112 at a distal end, the plunger 112 being formed of a pliable material, such as silicone, so as to form a substantially air-tight seal with the inside walls of the cylinder when the piston 104 is pressed into the cylinder to force the heated water and coffee grounds steeping in the cylinder through the filter in the filter cap 103 to produce the coffee beverage. It is appreciated that the features shown and described in FIGS. 1A-1B substantially correspond to the features shown and described in the examples in FIGS. 14-15 and can utilize a same or similar pressing operation as described in further detail below.

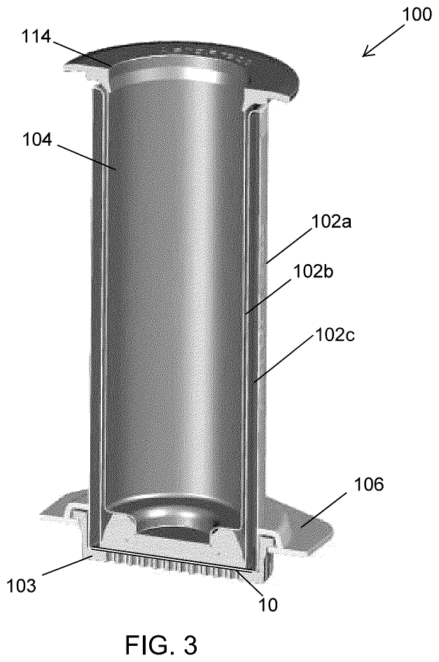

FIG. 3 shows a cross-sectional view of the press assembly, which shows the stainless steel cylinder 102 as double-walled, see sidewalls 102a and 102b, which improves insulation of the heated water in the cylinder during steeping and facilitate manual handling of the cylinder during pressing. Since metal, such as stainless steel conducts heat well, a metal cylinder can undesirably lower the temperature of the heated water below an optimal temperature during steeping or can cause the outside surface of the cylinder to become hot and uncomfortable to grasp during pressing. By providing a double-walled sidewall, the gap 102c between sidewalls 102a, 102b insulates the beverage and the temperature of the outer sidewall 102a is cooler and more comfortable to grasp during pressing. Preferably, a vacuum is drawn in the gap so as to thermally insulate the walls from each other, retaining heat inside the cylinder and allowing the outside of the cylinder to be handled manually. In some embodiments, the gap includes an insulative material, which can include any of: a polymer, Styrofoam, silica, ceramic, or any combination thereof. In some embodiments, the press cylinder is made from premium grade 304 stainless steel. In some embodiments, the sidewalls are each 0.1-1 mm thick stainless steel, typically 0.5 mm. In some embodiments, the sidewalls of the double-walled cylinder are separated by a gap, typically a space between 1-10 mm, typically about 3 mm, which can be an air gap or can be under vacuum for further enhanced insulative properties. In some embodiments, the outer cylinder dimensions are about 6.75″ by 4.375″, with an inner chamber diameter of about 57 mm, which provides a capacity of about 12 ounces. It is appreciated that various other dimensions could be realized.

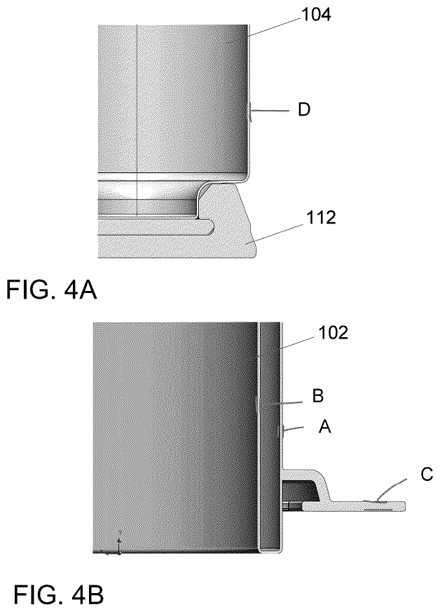

FIGS. 4A-4B shows detail views of the cross-section of the cylinder 102 and piston 104. As shown, each of the cylinder sidewall thicknesses A, B and piston sidewall thickness D are each 0.5 mm, and the gap between cylinder sidewalls is about 3 mm. The lateral support thickness C is about 2 mm. In this embodiment, the lateral support is a separate component that is coupled to the cylinder by a weld. While certain dimensions are shown here, it is appreciated that various other dimensions, gaps sizes and fabrication approaches can be used.

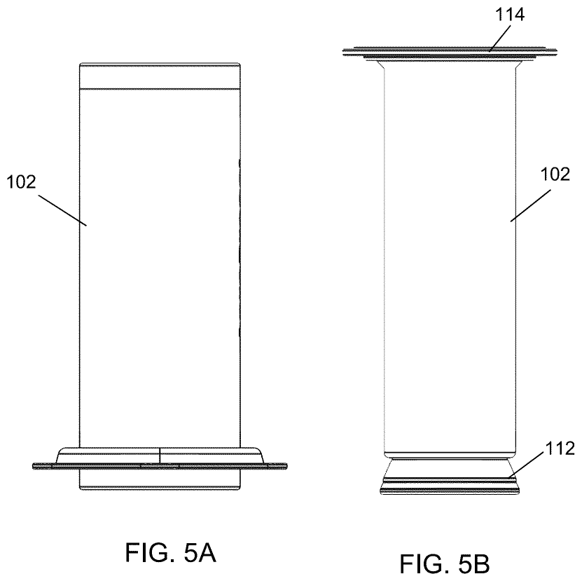

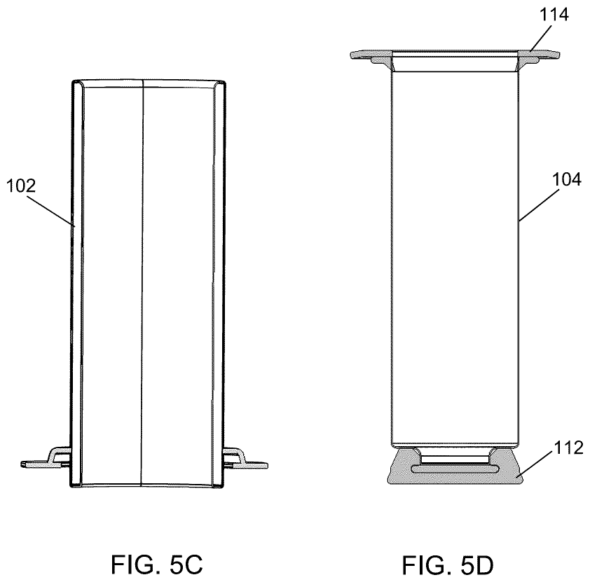

FIGS. 5A-5B show sides views of a hollow cylinder 102 and piston 104 each formed of stainless steel, in accordance with some embodiments. The piston includes a distal plunger 112 formed of an elastomeric material, such as silicone, and a proximal handle 114, defined as a flattened cap or flange, to facilitate manually pressing the piston in a downward direction through the chamber defined by the hollow cylinder and filter cap. FIGS. 5C-5D show cross-sectional side views of the hollow cylinder 102 and the piston. 104. As shown, the hollow cylinder is double-walled with a gap between walls for insulation. Preferably, a vacuum is drawn within the gap to provide thermal insulation, although it is appreciated other embodiments can include an air gap or a gap filled with an insulative material.

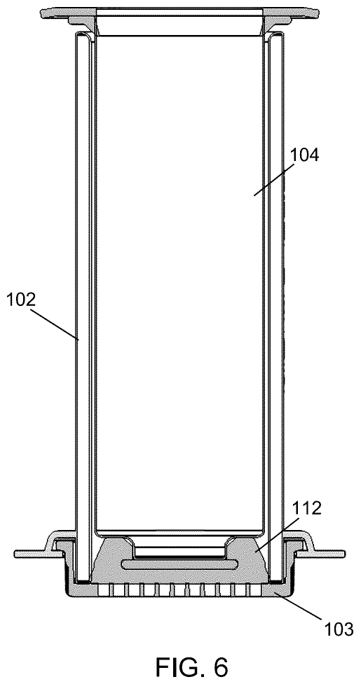

FIG. 6 shows an exemplary press assembly that includes the hollow cylinder 102 and piston 104 shown in FIGS. 5A-5D. As shown, the plunger 112 is sized to engage the inner walls along substantially the entire length of the hollow cylinder. A removable cap 103 is secured over the bottom opening of the hollow cylinder 102 and supports a filter (e.g. paper or metal) through which the coffee beverage is filtered upon pressing of the piston through the hollow cylinder. In this embodiment, the plunger is of a sufficient length such that the plunger, at least a distal portion thereof extends beyond the distal opening of the hollow cylinder, which aids in expelling any spent grounds from the hollow cylinder and cleaning of the press assembly.

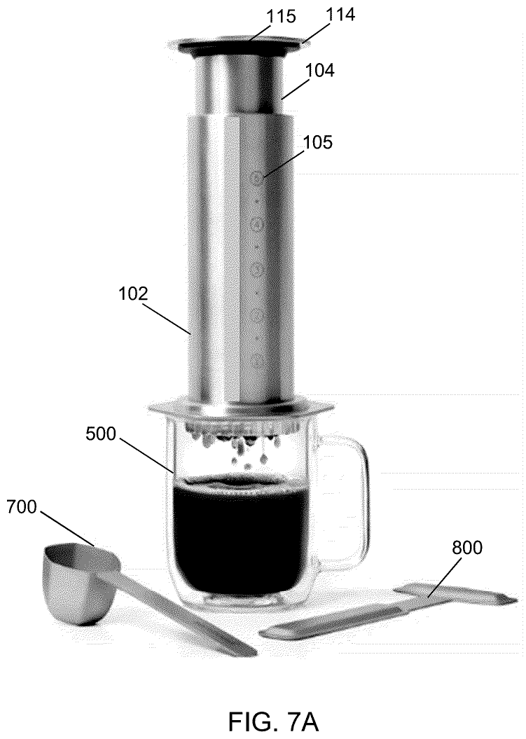

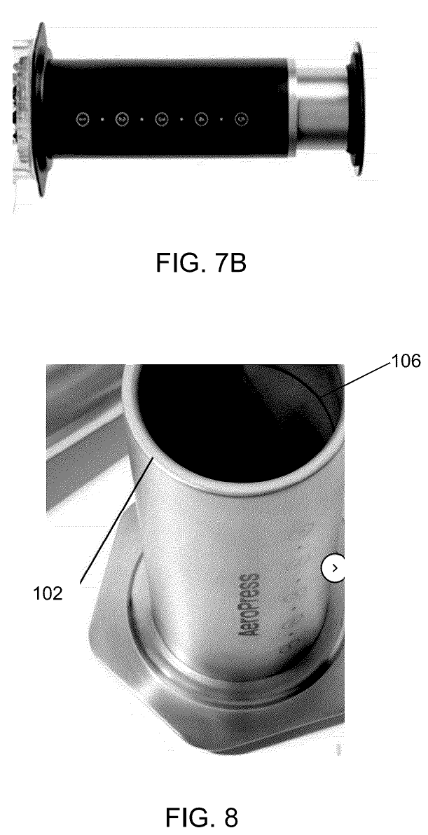

FIG. 7A shows an exemplary stainless steel press assembly that includes a stainless steel hollow cylinder 102, and stainless steel piston 104 disposed therein. The cylinder can include one or more outside fill markings 105 on an outer surface of the hollow cylinder to asisst in a user in filling the cylinder chamber by a set amount for a desired amount of coffee beverage or for a particular recipe. In this embodiment, the outside fill markings 105 are defined as five numbered circle marks and half-dots in between. The numbered marks indicate approximate brew volume/dilution guidance, and the little half-dots between them are intermediate level marks. The fill markings can be etched (e.g. laser etched) into the surface or applied by any suitable means (e.g. surface coating, etc). In some embodiments, the cylinder chamber holds between 10-15 oz (e.g. 10 oz, 12 oz, 13.5 oz). In this embodiment, the piston handle 114 further includes an inner elastomeric ring 115 on an underside where the flange of the handle would contact the top side of the cylinder. This elastomeric ring can prevent wear between metal surfaces during pressing. In some embodiments, the cylinder can further include an outer coating (e.g. polymer or epoxy coating), which can serve as a protective coating for the stainless steel surface and improve visibility of the fill markings or change aesthetics. The cylinder 102 can further include one or more inside fill markings 106 inside of the chamber as well. The fill marking(s) 106 can be defined as a line to aid a user in filling the chamber to a desired level, as shown in FIG. 8, and can be formed by etching (e.g. laser etching) or any suitable means. In this embodiment, the inside fill marking line corresponds to the outside fill markings. As shown in FIG. 8, the line corresponds to the five fill marking. While a single fill line is shown, it is appreciated that multiple corresponding lines could be used and/or numbered markings as well.

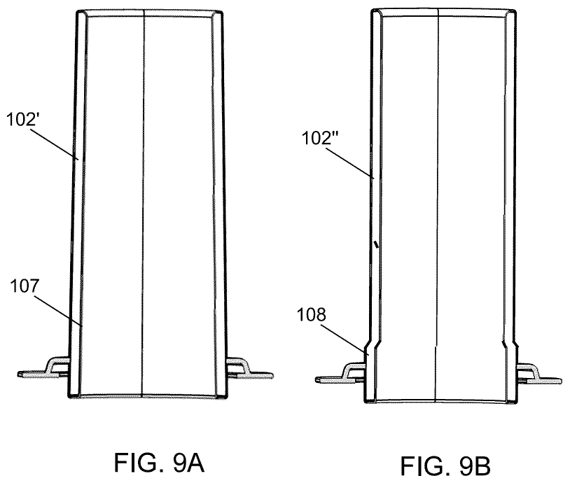

In another aspect, the cylinder can include a minor variation in the inside diameter of the cylinder. This can serve to adjust the force required during pressing (increase or decrease) and/or to reduce the stress/force against the seal in certain regions to avoid the elastomeric plunger from taking a set when stored. The change in cylinder diameter can be linear, such as a taper, or can be a stepped portion in any portion of the cylinder. In some embodiments, the cylinder is tapered or stepped such that the inside diameter is greater in a lower region of the cylinder, such as where the plunger is disposed when the press is stored. In FIG. 9A, the cylinder 102′ has a gradual taper 107 such that the diameter of the bottom opening is about 10% greater than the diameter of the top opeining. In some embodiments, the top opening is about 55 mm in diameter and the bottom opening is about 62 mm and the piston plunger head is about 62 mm in diameter when compressed. In the embodiment of FIG. 9B, the cylinder 102″ has a stepped portion 108 along the bottom region where the bottom diameter is increased (e.g. up to about 10%). In either case, the change in diameter is relatively minimal such that the operation of the press is still relatively the same as that of a constant diameter press, where the plunger is sealingly engaged with the inner walls of the cylinder along its length. The elastomeric flexible natures of the plunger seal accomodates minor changes in diameter, while the large diameter may reduce the pressure required to advance the plunger to or through the bottom opening or reduce stress on the plunger seal when stored.

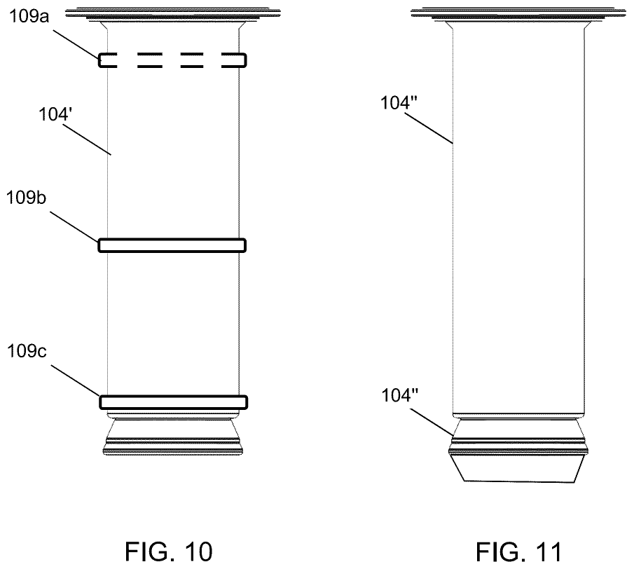

FIGS. 10-11 illustrate alternative piston designs 104′, 104″ with additional features that could be utilized in any of the embodiments herein. In some embodiments, the piston can include one or more centering features, such as a ring or lateral protrusions on the piston body that engage an inside of the cylinder so as to center the piston and prevent wobbling during pressing. The one or more centering features can be included anywhere on the piston, such as along the top, intermediate, or bottom portions. For illustrative purposes, the embodiment in FIG. 10 is shown with three centering features 109a,109b,109c. The top ring 109a comprises multiple protrusions, the intermediate feature 109b and lower feature 109c are defined as rings. FIG. 11 shows another piston 104″ having a laterally expandable plunger seal 114″, such as a conical design or bi-fold design, that expands in a lateral direction when pressed. Such seals can be used to insert the piston through a smaller diameter top opening in a cylinder design with variable inner diameter, such as those in FIGS. 9A-9B, thereby allowing the piston to be readily removable and inserted through the top of the cylinder for pressing in a standard manner, while still forming an air-tight seal along a majority of the length of the hollow cylinder.

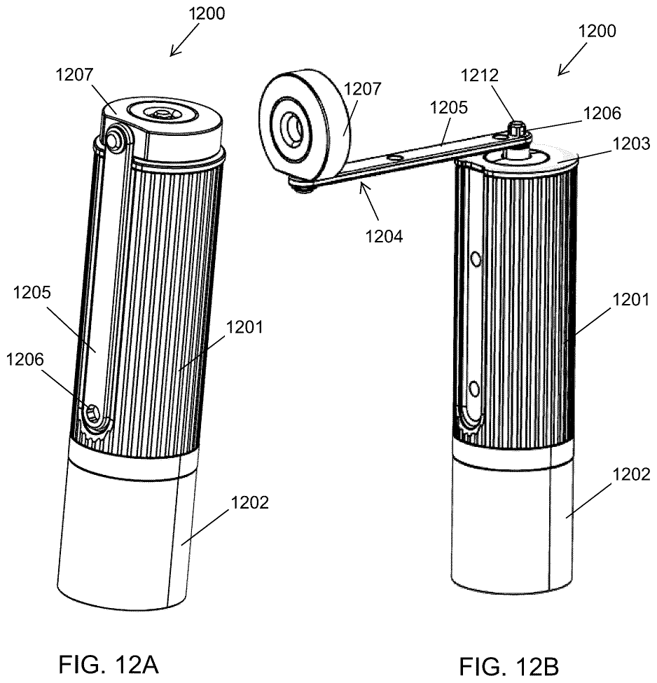

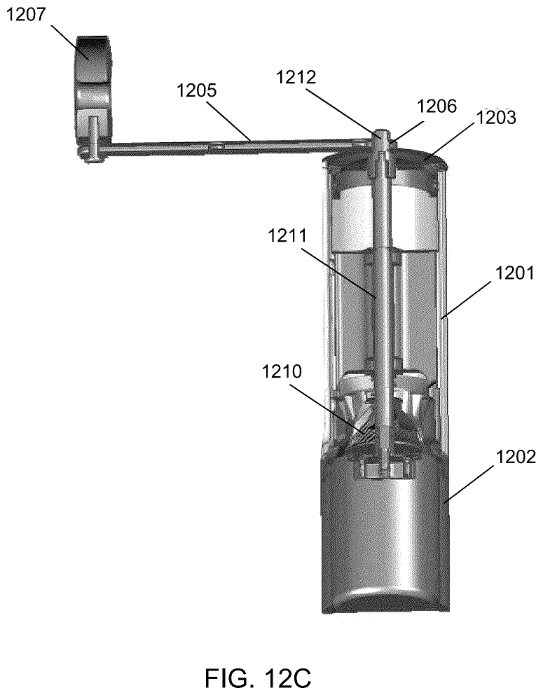

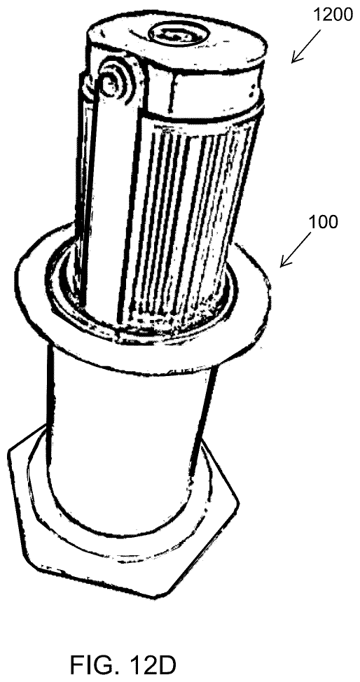

FIGS. 12A-12B illustrate an exemplary portable grinder 1200 with a crank handle 1204. The crank handle can be detached and positioned in a storage configuration, as in FIG. 12A, or positioned in a grinding configuration, as shown in FIG. 12B. As shown, the grinder includes a main body 1201 that is of a generally cylindrical shape and defines a housing that encloses internal grinding components (e.g. conical burr), and a grounds hopper 1202 attached at bottom.

As shown in FIG. 12A, in the storage configuration, the grinder has a reduced profile in which the crank arm 1204 that does not extend substantially beyond the outermost circumference of the main body 1201. This configuration allows the grinder to fit within the open cavity of the piston of a coffee press grinder (e.g. the press of FIG. 1 or any similar press), such as shown in FIG. 2D for storage and transport. The grinder arm includes an elongate member 1205 that extends between proximal handle 1207 and distal coupler 1206. In this embodiment, the main body 1201 is generally cylindrical but includes a flattened side along which the elongate member 1205 of the grinder arm can be positioned, with the handle 1207 releasably coupled to the top end of the main body. In some embodiments, the main body can include a recess along the main body that is dimensioned to receive the elongate member of the crank arm. In some embodiments, the handle 1207 includes a magnet by which the handle 1207 can be releasably secured to the main body in this position. In this embodiment, handle 1207 is generally circular in shape so that it aligns along the generally circular top end 1203 of the main body of the grinder. In some embodiments, handle 1207 includes a hole in the center so as to accommodate the top end of an axle 1212 of the grinding mechanism that protrudes from the top end of the main body. In some embodiments, the main body includes one or more magnets for magnetically holding the metal crank arm, which optionally can include one or more corresponding magnets. As can be seen in FIG. 12B, main body includes two such magnets 1209 that correspond to magnets 1219 on crank arm to magnetically secure the crank arm in the storage configuration.

As shown in FIG. 12B, in the grinding configuration, the crank arm has been repositioned so that the crank arm extends outward laterally from the top end 1203 of the main body, with the distal coupler 1206 operably engaged with the top end of the axle 1212 and the proximal handle 1207 extended outward to facilitate manual cranking of the axle with the handle. In this embodiment, the distal coupler 1206 is a hole of an engineered shape (e.g. square, polygonal, hexagon, etc.) that interfaces with a corresponding shape of the top end of the axle. Upon grinding by operating the crank arm, the rotation of the axle operates the grinding burr mechanism, thereby grinding the coffee beans and depositing the grinds below into a removable grinds hopper 1202 attached to the bottom end of the main body. The grinds hopper 1202 can be coupled to the main body by screw-threads, a snap-fit feature, or any suitable attachment means. After grinding, the grinds hopper can be removed from the main body and the grinds can be deposited into the outer cylinder of the coffee press before adding heated water and pressing the coffee beverage. Advantageously, the grinds hopper is of a cylindrical shape and sized to fit within the cylinder such that a user can flip onto the cylinder of the press, thereby depositing the grinds into the cylinder with little or no spillage of grinds. The grinds hopper can then be cleaned, if desired, and replaced on the main body and the crank arm can be repositioned into the storage configuration for storage of the grinder in the piston cavity or elsewhere after pressing.

FIG. 12C shows a sectional view of the portable grinder in the grinding configuration, illustrating the internal components. As can be seen, the main body 1201 houses the internal grinding mechanism, which includes a conical burr 1210 that is rotated by an axle 1211 that extends upwards so that a top end 1212 of the axle protrudes from the top end 1203 of the main body. The grinding mechanism empties the coffee grounds into the grinds jar1 202 releasably coupled to the bottom end of the main body 1201. While a particular type of grind mechanism, a conical burr, is shown here, it is appreciated that the grinder concepts are not limited to one particular type and various other mechanisms could be used. At top the crank arm is positioned in the grinding configuration with the elongate member 1205 extending laterally between the proximal handle 1207 and the distal coupler 1206 operable engaged with the top end 1212 of the axle1 211 such that manual cranking of the crank arm with the handle 1207 operates the grinder.

FIG. 12D illustrates an embodiment of the grinder 1200 that is sized and configured to fit within the open cavity of a piston of a coffee filter press 100, in accordance with some embodiments. It is noted that the open cavity of the piston is a smaller diameter than the cylinder. In some embodiments, the open cavity of the piston is about 4-6 cm in diameter, typically about 5.25 cm, and the outermost grinder (at least a distal half) has a smaller diameter. This configuration allows the portable grinder accessory to be easily stored in a compact manner within the press assembly. It is appreciated that various other sizes and dimensions could be realized. For example, the grinder could be of larger dimensions to fit with piston cavity of an oversized press (e.g. AeroPress XL press) or differing press types, such as the press in FIG. 1A or various other models (e.g. AeroPress Premium press).

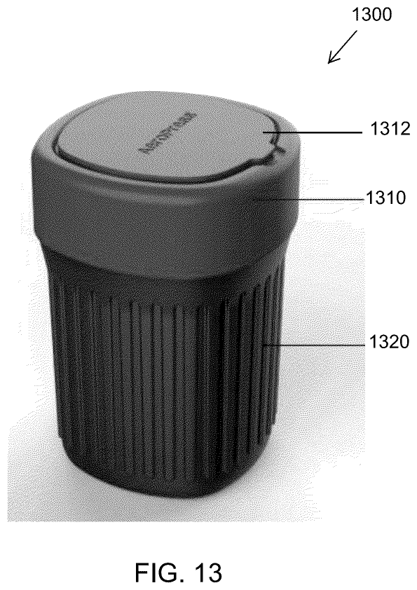

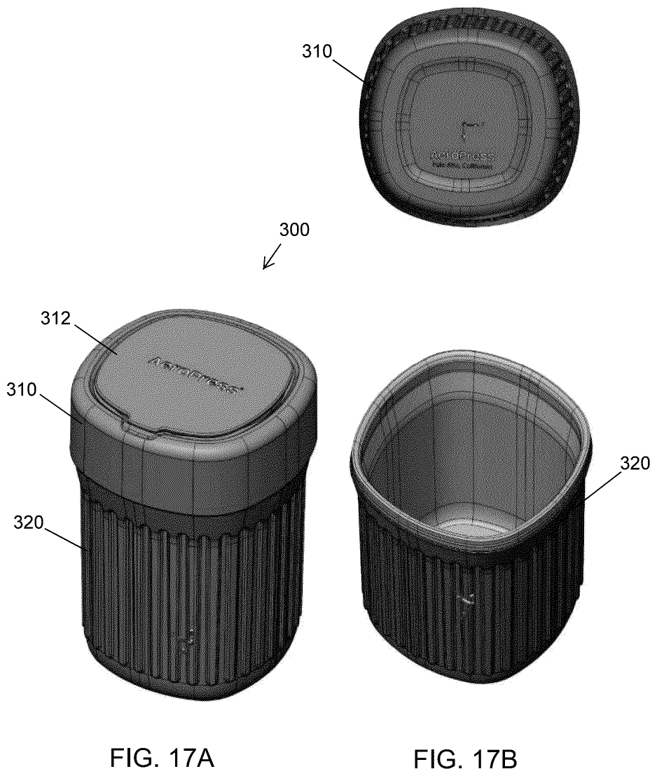

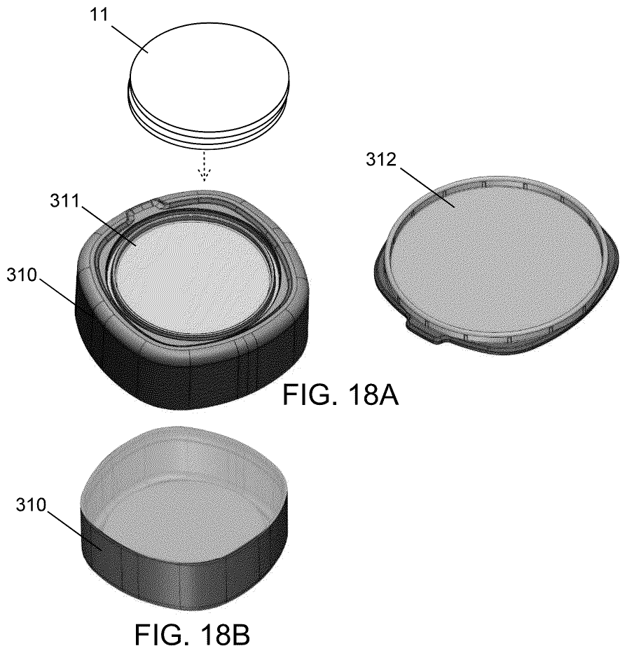

FIG. 13 illustrates an exemplary portable cup and lid assembly 300 for containing a portable coffee press assembly therein. The coffee beverage could be prepared by use of a filter press assembly, as described herein, or by use of any coffee maker. In some embodiments, this cup and lid assembly stores a portable coffee press assembly therein, the assembly can include a coffee press with piston and cylinder, a beverage cap and stirrer. In this embodiment, the cup and lid assembly includes beverage cup 1320 and a lid 1310 that couples atop the cup, the lid having a filter storage chamber accessed by opening top cover 1312. Additional details of the cup and lid assembly are shown and described in FIGS. 17A-18B.

To further aid in understanding certain aspects of the invention, an exemplary press and pressing operation is depicted below in FIG. 14. It is appreciated that the concepts described herein are not necessarily limited to the coffee presses depicted and could have various other uses and applications.

FIG. 14A illustrates an exemplary beverage press 1401 resting on a cup with a stirrer 409 deployed during the initial mixing stage, in accordance with various embodiments. FIG. 14B illustrates the exemplary beverage press 1401 with the piston 1404 deployed during the pressing stage, in accordance with various embodiments. It is appreciated that these aspects are exemplary to illustrate how the respective components function during use and that these aspects can pertain to any of the presses described herein. It is understood that the beverage press 1401 can be of various differing sizes and capacities, including the oversized beverage presses 1401 described in U.S. Patent Pub. No. 2024/0349932 filed Apr. 22, 2023, incorporated herein by reference. Exemplary operation of the beverage press 401 can be further understood by referring to FIGS. 14A-14B detailed further below.

The beverage press 1401 includes a hollow cylinder 1402, a removable filter cap 1403, and a piston 1404 with a flexible seal 1412. The hollow cylinder 1402 may have a top and bottom opening where the bottom opening is enclosed with the removable filter cap 1403. For example, a removable filter cap 1403 may be coupled with the bottom opening of the hollow cylinder 1402 enclosing one end of the hollow cylinder 1402. In an embodiment, the filter cap 403 can support a removable filter 1408. For example, a paper filter 408 may be positioned within a cavity of the filter cap 1403. The filter 1408 may be made out of any suitable material for filtering of the beverage. For example, the filter 1408 may be made out of metal, paper, etc. The filter 1408 may be captured between the cap 1403 and the hollow cylinder 1402 to strain particles from the liquid 1405. For example, a paper filter 1408 may be located on the cap 1403 facilitating the filtering of liquid 1405 being pressed through the hollow cylinder 1402. In an alternative embodiment, the filter 1408 may be integrated into the cap 1403 structure. For example, the cap 1403 may be designed to include a filtering structure suitable for filtering a beverage. While a perforated filter cap 1403 with multiple holes is shown, it is appreciated any filter cap 1403 could be used (e.g., pressure-activated valve cap).

The beverage press 1401 may further include the piston 1404 with a flexible seal 1412. The flexible seal 1412 may be located at a first end of the piston 1404. As a result, when the piston 1404 with the flexible seal 1412 is inserted within the hollow cylinder 1402, the piston 1404 with the seal 1412 may be utilized to press liquid 1405 through the hollow cylinder 1402. For example, the seal 1412 may be located at the bottom of the piston 1404, which can be used as a plunger to press a beverage through the body of the hollow cylinder 1402. In some embodiments, the flexible seal 1412 may be an airtight seal 1412. The removable piston 1404 may be inserted into the top opening and pressed downward to force liquid 1405 in the hollow cylinder 1402 through the filter cap 1403. In some embodiments, the piston 1404 may further include a stop 1414 and a support 1406. The stop 1414 may be located at the top of the piston 1404 (e.g., a second end of the piston 1404). For example, the stop 1414 may be located at the opposite end of the piston 1404 from the seal 1412. The support 1406 may extend laterally from near the bottom opening of the hollow cylinder 1402 and may be used to rest the beverage press 1401 on a vessel 1407 in which the beverage is dispensed. Thus, the support 1406 can be utilized to hold the beverage press 1401 on the mouth of an open vessel 1407 providing more stability during pressing. In some embodiments, the support 1406 has a regular polygonal shape. While support 1406 is shown in various embodiments as having a hexagonal shape. However, it is appreciated that the support 1406 may be any polygonal shape, or any suitable non-polygonal shape. The press assembly can further include a stirrer 1409 or stirring paddle having upper stop 1410 and a length, measured from its lower extremity (e.g., tip 411) to stop 1410, which is slightly less than the length of cylinder 1402. The stop 1410 prevents the tip 1411 of the paddle (e.g., stirrer 1409) from touching the cap 1403 or filter 1408 during stirring.

In operation, the press 1401 is placed on an open vessel 1407. Ground coffee or tea is put into the cylinder 1402. Hot water is added, and the mixture is stirred with paddle (e.g., stirrer 1409). The paddle (e.g., stirrer 1409) is then removed and piston 404 is inserted into the top opening and pressed downward to force the liquid 405 through the filter 408 and perforated cap 1403 and into the vessel 1407. The piston 1404 pressurizes the air 120, above the liquid 1405 and it is this pressurized air 1420 which forces the liquid 405 through the cap 1403. When the liquid 1405 is expelled, the press 1401 is then lifted off the vessel 1407 and the cap 1403 is removed. Finally piston 1404 is pressed further to eject the spent puck 1421 of coffee or tea into a waste receptacle.

The piston 1404 is capped with a flexible plunger 1412 that engages the inside of the cylinder 1402 and forms a substantially air-tight seal. The plunger can be made of silicone or any suitable material. The plunger 1412 preferably has its maximum diameter 1413 at its lowest point in order to wipe clean the inside of the cylinder 1402 when the maximum diameter 1413 is pushed fully through the cylinder 1402 with the cap 1403 removed during ejection of the spent puck 1421. The piston 1404 has a stop 1414 which limits the maximum travel of the piston 1404 but permits the maximum diameter 1413 of the plunger 1412 to extend beyond the bottom opening of the cylinder 402 with the cap 1403 removed to eject the spent puck 1421.

The perforated cap 1403 has one or more holes on the bottom. In some embodiments, the cap 1403 includes a single central opening with a pressure-activated valve. In the embodiment shown, the cap 1403 includes multiple holes to allow flow of beverage therethrough. In the embodiment shown, the cap 1403 further includes multiple drain holes 1415, adjacent to and radially external to a perimeter line defined by the outer circumference of the bottom of cylinder 1402. These drain holes 1415 relieve pressure between the outer wall of the cylinder 1402 and the inner wall of the cap 1403 and prevent leakage out of the top edge of the cap 1403.

In FIGS. 14A and 14B, perforated cap 1403 is attached to cylinder 1402 with a twist lock 1416. This twist lock 1416 can include four ramped grooves in the support/base that receive correspondingly shaped tabs in the filter cap 1403. This attachment can be used to attach the filter cap 1403 in any of the beverage presses described herein. Alternatively, various other attachment means could be used. It is further appreciated that in any of the embodiments here, the cap could be a perforated cap, as shown, or could be a flow control filter cap, such as that described in U.S. Pat. No. 12,053,114 incorporated herein by reference.

FIGS. 14-15 also illustrate a central bottom step 1418 which extends below the rim of the open vessel 407 in order to keep the press 1401 from slipping off the vessel 1407. In FIGS. 14 and 15, this bottom step 1418 is the lower portion of cap 1403. This central bottom step 418 may or may not contact the inner walls of the vessel 407 depending on the size of the opening of the vessel 1407. Supports 1406 and 1406A are shaped to permit air to pass readily out of the open vessel 1407 when the press 1401 is resting on top of the vessel 407 and liquid 405 is entering the vessel 1407. The twist lock 416 of FIG. 14 and FIG. 15 has through-holes 1422 which achieve this.

FIG. 15 illustrates and alternative version of the invention with the support 1506A being a portion of the cap that extends radially outward from the main body of cap 1503A. This figure also illustrates an alternative attachment method in which the cap is attached to the cylinder with a screw thread 1517. Yet another alternative would be to secure the cap to the cylinder with a latch. Any suitable attachment means could be used. The figure illustrates a central bottom step 1518 which extends below the rim of the open vessel in order to keep the press from slipping off the vessel. In prior embodiments, this bottom step is the lower portion of the cap. In the embodiment of FIG. 15, bottom step 1518 is an extension below the lower surface of cap 1503A. The alternative cap and support of the embodiment of FIG. 15 can optionally include an upper cavity 1519 to collect liquid which leaks between the cylinder 1502 and the cap 1503A. Supports 1506 and 1506A are shaped to permit air to pass readily out of the open vessel when the press is resting on top of the vessel and liquid is entering the vessel. The twist lock of prior embodiments has through-holes which achieve this function. Optionally, the bottom surface of support 1606A can be roughened or grooved to achieve this same result.

It is appreciated that a wide range of dimensions for the press components are possible. In some embodiments, a cylinder 1402 having an inside diameter of approximately 402.25 inches and a length of approximately 5 inches has been found to perform very well for pressing a quantity of beverage suitable for a single serving of beverage (e.g., 250 ml capacity), for example, to dispense an amount suitable for a standard cup of coffee or tea. In some embodiments, a cylinder 1402 having a larger diameter and height is used for dispensing a larger quantity of beverage, such as twice the capacity (e.g., 500 ml or more). Accordingly, accessory components such as the cup and lid assembly can be sized appropriately to accommodate presses of various sizes.

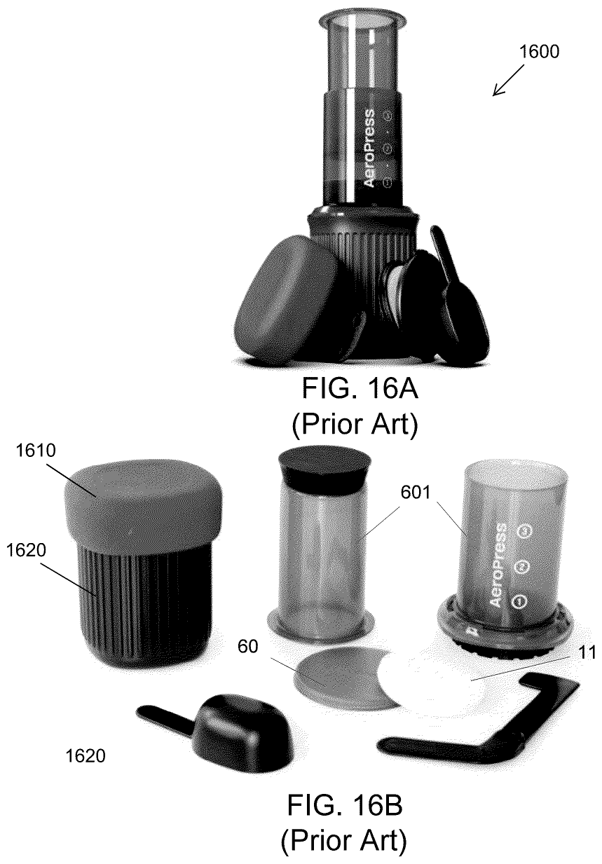

FIGS. 16A-16B illustrate a conventional travel press assembly with unitary flexible lid. In a conventional portable travel assembly 1600, a portable coffee press 1601 and associated components (e.g. scoop, stirrer, etc.) fits within a beverage cup 1620 and a flexible cap 1610 is pushed over the cup to hold the assembly in place for transport. The flexible cap 1610 is formed of a rubber-like material, such as silicone, and is loosely fit over the cup. Accordingly, the flexible cap does not securely couple or seal with the cap such that it is not suitable to contain a heated beverage within the cup when used for drinking. Also, the paper filter stack 11 is stored in a separate filter holder 60. Accordingly, there remains a need for an improved portable cup and lid that further facilitate making and drinking of filter pressed coffee beverages and improve portability. As detailed below, the lid 1310 improves upon the conventional flexible cap in several aspects, namely, providing a more secure attachment to the cup to securely maintain the press assembly during transport, sealing a more rigid lid to the cup to provide a secure and sealed lid when using the cup for drinking the hot beverage, and by storing the filters within the lid itself, thereby avoiding potential loss of filter(s). These advantageous features of the cap are described in further detail below.

FIGS. 17A-17B illustrate an exemplary portable travel cup and lid assembly 1300 for storing a portable or travel press assembly that includes a lid 1310 that securely fits atop cup 320, as shown in FIG. 17A. The lid 1310 further includes a filter storage chamber for storing one or more filters, typically a stack of paper filters. In this embodiment, the filter storage chamber is accessed by opening a top cover 1312. The top cover can be completely removable or, in some embodiments, include an attachment such as a living hinge or tether. In this embodiment, the top cover includes a front flap to facilitate digitally flipping the cover open to remove a filter in preparation for pressing. As can be seen in FIB. 17B, the lid 1310 can be shaped as a shell or concave shape so as to define an open cavity that opens toward the bottom opening that fits atop the cup. This design increases the clearance of the enclosure above the top of the cup so as to accommodate the press assembly and associated components therein. Also shown in FIG. 1 7B, the inner surface of the lid adjacent the bottom opening includes a seal-tight coupling feature, such as a snap-fit interface between the lid and the cup, so as to sealingly secure the lid atop the cup to enable the cup and lid to function as a travel container for the pressed coffee beverage and also to function as a sealed lid when using the cup for drinking.

FIGS. 18A-18B further illustrate the lid 1310 having filter storage, in accordance with some embodiments. As shown in FIG. 18A, the openable cover 1312 has been removed from the lid 1310 and a paper filter stack 11 is placed within the filter storage chamber 1311. In this embodiment, the filter storage chamber is dimensioned to hold a standard stack of paper filters (e.g. 50 filters). It is appreciated that the chamber could be dimensioned to hold more or less filters, or to hold a different types of filters (e.g. one or more metal filters), or a combination of paper and metal filters. As shown in FIG. 18B, the lid 1310 includes sidewalls forming the open cavity to accommodate the filter press assembly when disposed between the cup and lid. In some embodiments, the depth of the open cavity is between 1-10 cm, typically about 2-5 cm.

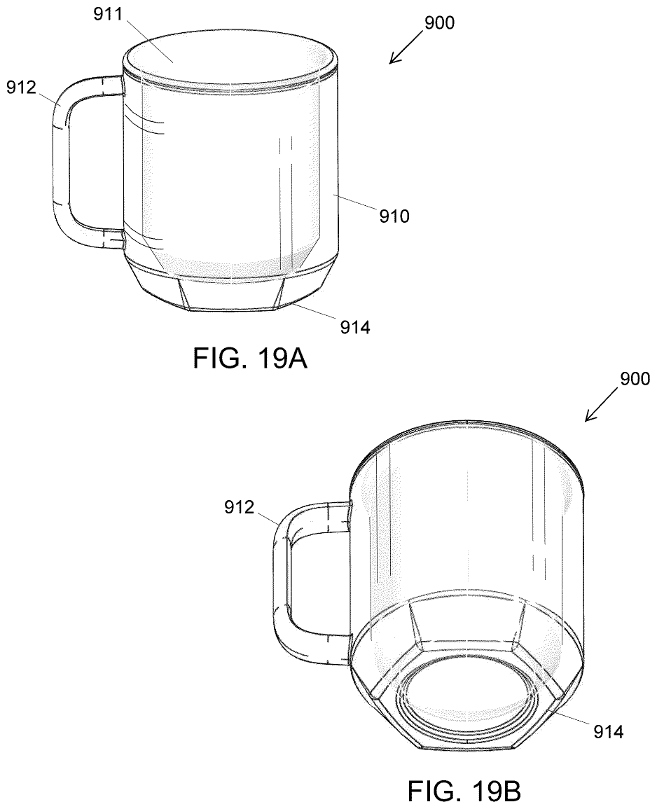

FIGS. 19A-19B illustrate an exemplary portable drinking container. In this embodiment, the drinking container is a double-walled glass mug 1900, which can be used for drinking a coffee beverage made from the portable coffee presses described herein. The mug is defined by a container body 1910 having a chamber 1911 configured to hold a liquid. In this embodiment, the container 1910 is formed of glass and has double-walled sidewalls to better insulate the beverage and facilitate manual handling. While glass is less of thermal conductor than metal, it still conducts significant heat as compared to opaque ceramic, from which most conventional mugs are made. The mug further includes a handle 1912 extending from the container body. The handle can be made from the same or different material as the container body. In the embodiment shown, the container body and handle are both formed of glass.

The container body 1910 has a reduced size base 1914 having a diameter (i.e. range of diameters) less than the upper diameter of the container, which keeps beverage hotter longer. Typically, the base has a diameter that is smaller than the upper diameter by at least 20%, 25%, or 33% or more. In some embodiments, the base can be a standard circular shape. In the embodiment shown, the base has a polygonal shape having four or more sides so as to improve stability of the mug and prevent tipping. The polygonal shape provides an increased moment at the vertices of the polygon, which improves stability by increasing the tipping force required to tip the cup. The polygonal further provides an improved aesthetic that matches the design of the press. In the embodiment shown, the base has a hexagonal shape, as shown in FIG. 19B, that corresponds to the hexagonal shape of the support of the press assembly.

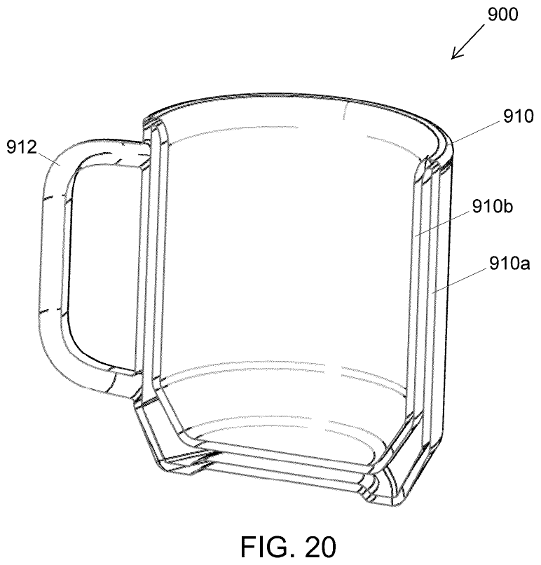

FIG. 20 illustrates a sectional view of the glass mug that shows the double-walled aspect of the mug, in accordance with some embodiments. As shown, the glass mug container body 1910 is double-walled, having an outer wall 1910a and an inner wall 1910b, there being a gap or space between the double-walls to improve insulative properties of the mug and facilitate manual handling of the mug when filled with a heated beverage. The container body can include air in the gap or a vacuum can be drawn in the space to further enhance insulative properties. In some embodiments, the gap can be between 1-10 mm, typically about 2-5 mm.

While the above is a complete description of specific embodiments of the invention, the above description should not be taken as limiting the scope of the invention as defined by the claims. It is understood that the terms “substantially” and “about” means +/−10% of any recited value. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. Any references cited herein are incorporated by reference herein in their entirety.

What is claimed is:

1. A portable assembly for making beverages, the portable assembly comprising:
a beverage filter press including:
a hollow cylinder having a first opening at a top side and a second opening at a bottom side, wherein the hollow cylinder is made from stainless steel, wherein the hollow cylinder has double-walled sidewalls with a gap therebetween to improve thermal insulation between inner and outer walls and facilitate manual handling of the hollow cylinder during pressing of a hot beverage;
a removable filter cap couplable to the hollow cylinder so as to enclose the second opening thereby forming a chamber within the hollow cylinder, wherein the filter cap is configured to support a filter therein, and
a piston configured to be disposed within the hollow cylinder and having a distal plunger that creates an airtight seal when coupled with the hollow cylinder and a proximal handle such that manually pressing with downward pressure, the air-tight seal by the plunger forces liquid in the chamber of the hollow cylinder through the filter cap; and
a lateral support extending from the hollow cylinder or the filter cap for holding the press above the mouth of an open vessel during pressing.

2. The portable assembly of claim 1, wherein a main body of the piston is formed of a stainless steel.

3. The portable assembly of claim 2, wherein the cylinder has an outer coating.

4. The portable assembly of claim 1, wherein a gap between double-walled sidewalls is under vacuum.

5. The portable assembly of claim 1, wherein a chamber of the hollow cylinder has a capacity between 10-13.5 oz.

6. The portable assembly of claim 1, wherein the hollow cylinder has numbered fill markings on an outer surface of the cylinder.

7. The portable assembly of claim 1, wherein the hollow cylinder has one or more fill markings defined by a laser etched line inside the cylinder.

8. The portable assembly of claim 1, wherein the hollow cylinder has a substantially constant diameter within +/10% of a set value.

9. The portable assembly of claim 1, wherein the first opening is smaller in diameter than the second opening such that the hollow cylinder has an internal taper or stepped portion.

10. The portable assembly of claim 9, wherein the piston is removable and insertable through the first opening.

11. The portable assembly of claim 1, wherein a gap between double-walled sidewalls includes an insulating material comprising any of: a polymer, Styrofoam, silica, or any combination thereof.

12. A portable grinder for manually grinding coffee beans, the portable grinder comprising:
an elongate body of a generally cylindrical shape extending longitudinally between a top end and a bottom end, wherein the elongate body at least partly encloses a grinding mechanism that includes an axle with a cone burr, wherein a top end of the axle extends from the top end of the elongate body;
a crank arm have an elongate member extending longitudinally between a proximal handle and a distal coupler, the handle configured for manual grinding and the distal coupler configured for operably engaging with the top end of the axle,
wherein the crank arm is removable from the elongate body,
wherein the grinder has a storage configuration in which the proximal handle removably couples with the top end of the elongate body with the elongate member extending longitudinally along a side of the elongate body so that the grinder has a reduced profile for storage; and
wherein the grinder has a grinding configuration in which the distal coupler is coupled to the top end of the axle and the elongate member extends laterally such that manually revolving the crank arm by the handle rotates the axle, thereby rotating the cone burr for grinding.

13. The portable grinder of claim 12, wherein a portion of the elongate body has a flattened side along which the elongate member of the crank arm extends in the storage configuration.

14. The portable grinder of claim 12, wherein the proximal handle comprises a generally round shape so as to fit atop the top end of the generally cylindrically shaped elongate body.

15. The portable grinder of claim 12, wherein the proximal handle is magnetic so as to releasably secure the proximal handle atop the elongate body in the storage configuration.

16. The portable grinder of claim 12, wherein the crank arm is magnetically held to the grinder body when in the storage configuration by one or more magnets on the main body or on both the main body and the crank handle.

17. The portable grinder of claim 12, wherein the distal coupler is a hole formed along a distal region of the elongate member that is shaped to securely engage with the top end of the axle.

18. The portable assembly of claim 12, further comprising a grounds hopper or jar of a cylindrical shape that removably couples to the bottom end of the elongate body.

19. A lid for a portable cup that contains a portable press assembly, the lid comprising:
a main body configured to removably and sealingly couple with the portable cup so as to contain a beverage disposed therein, wherein the main body is defined as a shell so as to accommodate the portable press assembly extending beyond a top of the cup; and
a storage chamber defined in a top portion of the main body, the chamber being sized and dimensioned to store one or more filters for use with the portable press assembly; and
a top cover that encloses the storage chamber for storage of the paper filters, wherein the top cover is removable or openable to access the storage cavity.

20. The lid of claim 19, further comprising:
wherein the storage chamber is sized and dimensioned to hold a stack of paper filters.

21. The lid of claim 20, wherein the stack of paper filters comprises 50 paper filters or more.

22. The lid of claim 19, wherein the top cover is fully removable.

23. The lid of claim 19, wherein the top cover comprises a snap-fit feature that circumscribes a bottom side of the top cover so as to releasably couple over the storage chamber.

24. The lid of claim 19, wherein the main body comprises an open cavity that opens to a bottom opening that securely couples atop the portable cup, so as to secure a portable press assembly when disposed within the portable cup for storage.

25. The lid of claim 24, wherein the main body comprises threads or a snap-fit feature that circumscribe the bottom opening that interface with a top of the portable cup, thereby sealingly coupling the lid to the portable cup so as to seal a hot beverage in the cup when used for drinking.

26. A mug for holding hot beverages, the mug comprising:
a container body having a chamber configured to hold a liquid, wherein the container is formed of glass and has double-walled sidewalls to insulate the beverage and facilitate manual handling of the mug when holding a hot beverage;
a base configured to support the container upright, wherein the base comprises a polygonal shape having four or more sides so as to improve stability of the mug; and
a handle extending from the container body.

27. The mug of claim 26, wherein the container body and handle are both formed of glass.

28. The mug of claim 26, wherein the polygonal shape comprises a hexagon.
